(19) United States
(12) Patent Application Publication
(10) Pub. No.: US 2024/0369229 A1
(43) Pub. Date: Nov. 7, 2024

(54) STOVETOP SAFETY SYSTEM

(71) Applicant: LORANE INVESTMENTS LLC, ORLANDO, FL (US)

(72) Inventor: Ashley L. Malcolm, Orlando, FL (US)

(73) Assignee: LORANE INVESTMENTS LLC, ORLANDO, FL (US)

(21) Appl. No.: 18/773,013

(22) Filed: Jul. 15, 2024

Related U.S. Application Data
(63) Continuation-in-part of application No. 17/374,220, filed on Jul. 13, 2021, now Pat. No. 12,038,180.
(60) Provisional application No. 63/050,961, filed on Jul. 13, 2020.

(51) Int. Cl. F24C 3/12; F24C 7/08; H05B 1/02; H05B 3/74

(52) U.S. Cl. CPC F24C 3/126; F24C 7/083; H05B 1/0258; H05B 3/746; H05B 2213/05

(57) ABSTRACT

A cooking device safety system and smart system method embodiments are described herein. The system includes cooking device, at least one first sensor to detect the presence of an object on or adjacent to a stovetop burner, at least one second sensor to detect a condition of the stovetop burner, at least one third sensor to detect weight of the object on the burner and/or temperature of the burner, a microcontroller to detect a date and time of use of the cooking device, wherein the system collects and stores data related to the inputs from the first sensor, second sensor and/or third sensor(s) to determine a cooking pattern of a user. The system further includes wherein based on the cooking pattern of the user, the system provides an output to the user via a signal output device, and at least one transceiver to send a signal from the first, second and/or third sensor(s) to a remote device.

### CROSS-REFERENCE TO RELATED APPLICATIONS

This application is a continuation-in-part application of U.S. Non-Provisional application Ser. No. 17/374,220 filed on Jul. 13, 2021, which claims priority to U.S. Provisional Application No. 63/050,961 filed Jul. 13, 2020, all of which are incorporated by reference herein in their entireties.

### BACKGROUND

Stove-related fires are one of the most common causes of household fires. The number of stove-related fires increase as the population of users increases, and due to the aging of the population resulting in dementia in older users, Alzheimer's Disease, and general forgetfulness, the risk of stove-related fires is increasing. Users with mental or physical disabilities are also at risk. Thirty percent of stove-related fires; however, occur in homes where operators are 65 years of age or older. A large portion of cooking related injuries or deaths occur as a result of leaving the stove-top burner on without supervision.

### SUMMARY

Embodiments described herein includes systems and methods to prevent accidents involving one of the most dangerous appliances in most households—the stove. As most injuries or deaths result from unattended use of the stove-top, either by way of accident, or forgetfulness, embodiments described herein serve to resolve these issues and provide safety elements and checkpoints in an effort to prevent these accidents.

In non-limiting embodiments described herein, there are stovetop safety systems which are a component of the stove system, in some embodiments, manufactured as one complete unit with these safety features, or which may be retrofitted to an existing stove.

In one non-limiting embodiment, there is provided a stovetop safety system including at least one first sensor to detect the presence of an object on or adjacent to a stovetop burner, optionally, at least one second sensor to detect a condition of the stovetop burner, at least one transceiver to send a signal from the at least one first sensor and/or the at least one second sensor to a remote device, a microcontroller comprising a timer; and a signal output device.

In another non-limiting embodiment, a method for providing a safe stovetop system environment is provided including detecting a status of a stovetop burner, and detecting the presence of an object on or near the stovetop burner, wherein when the stovetop burner has an activated status and an object is detected on or near the burner, the system detects whether a threshold cooking time has been exceeded. If the threshold cooking time has been exceeded, the system: 1) produces an alert via a signal output device; 2) sends an alert to a remote device; and/or 3) inactivates the stovetop burner.

In yet another non-limiting embodiment, a method for providing a safe stovetop system environment is provided. The method includes detecting a status of a stovetop burner, detecting no object on the stovetop burner, wherein when the stovetop burner comprises an activated status and no object is detected on the burner, the system detects whether a threshold non-cooking time has been exceeded. If the non-cooking time threshold has been exceeded, the system: 1) produces an alert via a signal output device; 2) sends an alert to a remote device; and/or 3) inactivates the cooking device.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 provides a schematic of a stovetop safety system embodiment;

FIG. 2 provides a flowchart demonstrating a method for providing a safe stovetop system environment.

FIG. 3 provides a flowchart demonstrating a method of using a cooking device safety system according to one embodiment.

### DETAILED DESCRIPTION

Embodiments of the invention disclosed herein include a system for optimal cooking operations and pre-hazard monitoring. In one particular embodiment, the system includes a system for optimal cooking operations and error condition monitoring using continuous and adaptive machine learning enabling user specific and customizable optimizable, specific, and customizable cooking operations, and identification of error conditions and user specific non-optimal conditions that may arise during cooking operations. Accordingly, in one embodiment, is provided a user focused system and method for an optimal cooking operation by effective combination of human intervention through machine-based assistance, and computing and sensor based automated notifications.

For the purposes of promoting an understanding of the principles and operation of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to those skilled in the art to which the invention pertains.

It is to be noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced item. Furthermore, to the extent that the terms “including,” “includes,” “having,” “has,” “with,” or variants thereof are used in either the detailed description and/or the claims, such terms are intended to be inclusive in a manner similar to the term “comprising.” The modifier “about” used in connection with a quantity is inclusive of the stated value and has the meaning dictated by the context (e.g., includes the degree of error associated with measurement of the particular quantity). It is to be noted that all ranges disclosed within this specification are inclusive and are independently combinable.

The term “cooking device” includes but is not limited to a stovetop, a stove, an oven, a microwave, a toaster, a barbeque grill or other cooking device. Throughout the description any reference to any one type of cooking device may be extrapolated to refer to any type of cooking device mentioned herein.

The terminology used herein is for the purpose of describing particular embodiments only and is not intended to be limiting. As used herein, the singular forms “a,” “an,” and “the” are intended to include the plural forms as well, unless the context clearly indicates otherwise these terms do not denote a limitation of quantity, but rather denote the presence of at least one of the referenced item. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order, quantity or importance, but rather the terms first, second, etc., are used to distinguish one element from another.

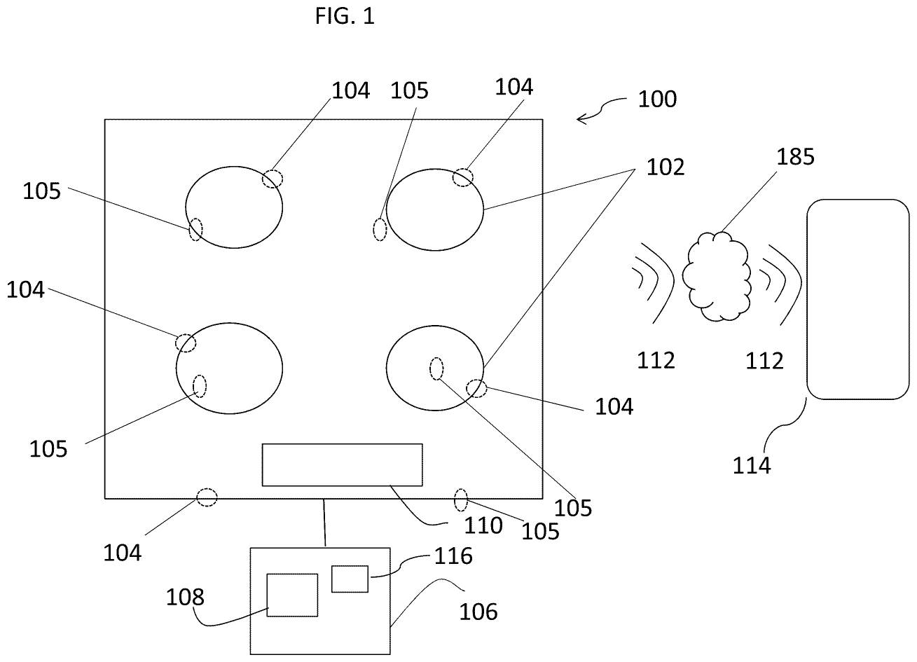

Turning to the drawings, FIG. 1 includes a schematic of a cooking device safety system including a stovetop safety system 100 including one or more burners 102, the one or more burners comprising a heating element. When the one or more burners 102 are activated, heat is produced. The system 100 further includes at least one first sensor 104 to detect the presence of an object on or adjacent to a stovetop burner, and optionally, at least one second sensor 105 to detect a condition of the stovetop burner. The system 100 may further include at least one transceiver 108 to receive a signal from the at least one first sensor 104 and/or the at least one second sensor 105, and to optionally, send a signal to a remote device 114. The system 100 further includes a microcontroller 106 comprising a timer 116, and a signal output device 110. The system 100 may be communicatively connected 112 to a remote device 114 by way of a wired or wireless connection. In FIG. 1, a wireless connection is shown between the system 100 and a remote device 114. The remote device 114 may be any device; however, in FIG. 1, this device is embodied as a cellular device. The remote device 114 may be programmed by software or hardware or other means to control the system 100 via remote inputs on the remote device 114. In the embodiment shown in FIG. 1 a cloud 185 may optionally be used to back up or store information received from the system. The cloud 185 is shown as positioned between the system and the remote device 114; however, this is not meant to be limiting. The system may provide information transfer and storage in a cloud 185 by wired or wireless connection 112 and may communicate information to a remote device 114, or, alternatively, the system may include a cloud 185 for information storage and backup or a remote device 114.

In another non-limiting embodiment, the stovetop safety system may be configured to include one or more sensors 104, 105 to detect the presence of an object on or adjacent to a stovetop burner, or inside an oven, and to detect, optionally, the condition of a stovetop burner and/or an oven. The system 100 may further include at least one transceiver 108 to receive a signal from the one or more sensors 104, 105, and to, optionally, send a signal to a remote device 114. Alternatively, or in addition to sending a signal to a remote device 114 as in the embodiment described above, the system 100 may alert a user via a signal output component 110 associated with the system. For example, the system 100 may sound an alarm through a signal output device 110 comprising a speaker on the system itself. In another embodiment, the signal output component 110 may include a visual indicator, which may flash or change color or turn on as an alarm. The signal output component 110 may provide an output to a user or third party by any means known in the art including, visual, tactile, auditory, gustatory, or by way of a smellant or olfactory output to provide an alert or a communication to a user or third party.

The microcontroller 106 described in embodiments of the system 100 herein may, optionally, communicate with a neural network (Cloud) cloud 185, which may be able to detect a pattern of use of the cooking device and provide a suggestion based on that pattern, or, may detect an error condition based on that pattern. For example, if a user routinely cooks during the week, but not on the weekend, the neural network will learn this pattern of cooking and may, for example, detect an error condition should the cooking device be in use on the weekend. In another example, if a user routinely bakes at 350 degrees for an hour, the neural network can learn and store this information, such that if the oven is left on 350 degrees for a prolonged period of time, for example, longer than 2-3 hours, or at 450 degrees for a prolonged period, the system may issue an alert that the use is a non-traditional use for that user. This is another manner in which the system can detect error conditions and prevent accidents from occurring in the use of the cooking device. These examples are intended to be exemplary only and are not limiting examples of behaviors that may be learned by the neural network component of the system 100.

In some non-limiting embodiments the system embodiments described herein may work in conjunction with a personal digital virtual assistant (VA) such as such as SIRI, Amazon Alexa, Google Assistant, Cortana, or other) to extend functionality and operate the system, including communication between the system and a remote third party or remote third party device to improve and automate functionality of the system.

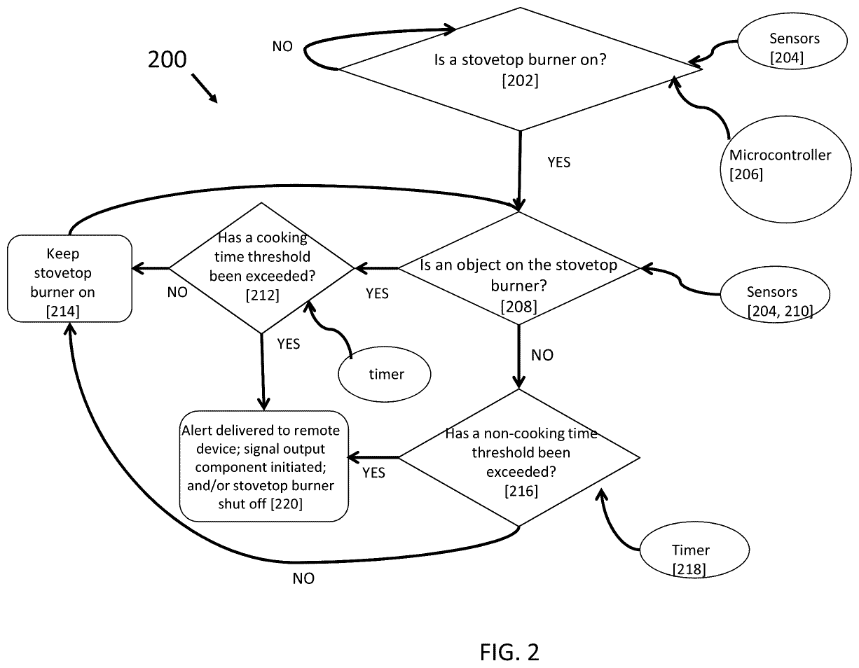

FIG. 2 provides a flowchart of a method 200 for providing a safe stovetop system 100 (or other cooking device) environment or use thereof. The method 200 includes circuitry or a microprocessor executing instructions, including a first determination of whether a stovetop burner is on or activated 202. If the system 100 determines that a stovetop burner is not activated, it returns to step 202 to make the same determination again. Once the determination is made that the stovetop burner is on or activated in step 202, which is based at least in part on sensor 204 input and/or microcontroller 206 input, the system 100 proceeds to step 208 to determine if an object is on or adjacent to the stovetop burner. Should the determination in step 208 be that no object is on or adjacent to the stovetop burner, based at least in part on sensor 204, 210 input, the system 100 proceeds to step 216 to determine whether a pre-set non-cooking time threshold has been exceeded. This determination is made at least in part based on input from a timer 218 as shown in FIG. 2. Should the answer to step 216 be no, the system continues to step 214 and keeps the stovetop burner on or activated, and returns to step 208.

At step 208 if the answer is yes, that an object is on the stovetop burner, the system 100 proceeds to step 212 to detect whether a preset cooking time threshold has been exceeded at step 212. As one may suspect, a cooking time threshold indicates the amount of time required to heat or cook the contents within a pan or pot placed on a stove. In embodiments where the cooking device is an oven, a cooking time threshold may be the amount of time required to bake or broil an item, for example. It is understood that typically a cooking-time threshold would differ from a non-cooking time threshold when an object is not placed on the activated burner. Consequently, based on the time frames provided herein and what is generally known to those skilled in the art, the system would send an alert based on whether the condition of the system includes a cooking time threshold or a non-cooking time threshold. The system will detect whether a cooking time threshold or non-cooking time threshold is appropriate based on sensor input and whether an object is detected on the stove (or in the oven, or otherwise associated with the cooking device as described in other examples herein).

If the system detects that a cooking time threshold has not been exceeded at step 212, the system moves to step 214, and the burner is left on. Should the system detect at step 212 that a cooking time threshold has been exceeded, or at step 216 that a non-cooking time threshold has been exceeded, the system would proceed to step 220, at which time the system 100 would deliver an alert to the user of the system/stovetop device via the signal output device 110, or to a remote device 114, or both, and/or the stovetop burner may be automatically powered off at step 220. Alternatively, or in addition, emergency personnel may be alerted at step 220. For example, the remote device may be a network run by a service provider who may contact emergency personnel upon receiving a signal or notification from the system. In other embodiments, the remote device may be emergency management (police, ambulance, fireman, or dispatch personnel for emergency management) who would dispatch said personnel to the system or the stove associated with the system that is sending alerts. In some instances, for example, should the system detect a non-cooking time or cooking time threshold has been exceeded, an alert may be delivered to a pre-designated list of emergency contacts. The alert may include an option for the pre-designated contact(s) to confirm whether emergency management (police, ambulance, and/or fireman) should be dispatched or contacted. In at least one embodiment, if no confirmation is received from a pre-designated emergency contact, and/or one cannot be reached, the emergency management may automatically be dispatched to the location of the cooking device, which can be determined as known to those skilled in the art or in the methods described herein. In other embodiments, the system is configured such that should the system detect a non-cooking time or cooking time threshold has been exceeded, an alert will be delivered directly to emergency personnel or dispatch for emergency personnel (i.e., emergency management) to immediately dispatch the emergency personnel to the location of the system.

In various embodiments herein, a first sand/or second sensor is described for detecting conditions required of the system. In one embodiment the sensors described herein may include a contact sensor. A contact sensor may be provided to detect a contact or insufficient contact between one object and another, for example, to detect contact or lack thereof between an object and a stove burner. In one embodiment, an alert may be delivered from the system based on detection from a contact sensor, and optionally, one or more sensors. The contact sensor may be positioned on any portion of the stove; however, in some non-limiting embodiments, the contact sensor may be positioned directly beneath or adjacent to a burner. The contact sensor may communication with other components of the system to alert a user when a contact has or has not been made with an object. Likewise, the contact sensor(s) may be in or around the oven to detect whether an object is placed within an oven.

In another embodiment, the sensor(s) may include one or more proximity sensors to detect an object that is within a range of the sensor. The proximity sensor, like the contact sensor, may be placed on or around the burner(s), or in or around the oven. Therefore, should an object be near the stovetop burner, or in an oven, an alert may be sent to a user.

In a further embodiment, a location sensor may be provided to detect a location of the system. For example, a remote device may monitor multiple systems, and consequently, may require information about a particular location of each system to detect which system requires attention or alerts. This location information for the system may be communicated to the remote device. The location or position of the system may be located by GPS, triangulation, or other methods known in the art. Tracking the location of the system is important in the instance that police, the fire department, an ambulance or other third party may need to be dispatched and sent to the location of the system. The remote device may include, in one non-limiting embodiment, a cellular phone, or a software application on a cellular phone.

In still other embodiments, the sensors described herein may include a temperature sensor, which may be used to detect whether a burner (or a heating element in an oven) is activated or inactivated. A temperature sensor may also be used to detect whether an object has been placed on or adjacent to a burner, or in an oven. Consequently, in at least one non-limiting embodiment, the system may be able to detect and send alerts with only one sensor. In one example that one sensor may be a temperature sensor to detect both an object in contact with a burner (or inside an oven) and to detect whether the burner (or oven) is activated or inactivated, in one non-limiting embodiment. Alerts may be delivered whether contact is sensed on the stove or an object is sensed in the oven or no contact or no object is sensed and when the temperature or other sensor detects the stovetop or oven is on or off.

Other non-limiting types of sensors that may be used in the system embodiments described herein may include visual sensors, visual heat sensors, thermographic or thermal imaging cameras, or light sensors. A visual sensor may include a camera, in a non-limiting embodiment, wherein the camera may identify the presence or absence of an object on or adjacent to a stovetop burner, or inside or adjacent to an oven. A visual sensor may also communicate with the neural network on the type (size, shape, material, color) of objects to learn patterns of heating times and temperatures against the use of those objects. Detection and learning of patterns provides the ability to set favorites in terms of types of foods, temperature settings, timer settings, and other cooking settings based on prior use of the device. For example, if the same temperature setting for the oven and the same cook time has been set three times in a row, this can be stored as a favorite. As another example, if at 9:00 am every morning, the stovetop is powered on to a particular temperature for a particular amount of time, this can be selected as a favorite in the system. Favorites can be saved in the system by the user, and can be titled for various types of foods cooked. Thereafter, the user can select a favorite by contact with the system or by voice command via the system to set the stove or oven according to the favorite particulars.

In another example, detection and learning of cooking patterns by the system may occur by detecting that a user makes the same meal on the stove every week, on the same day of the week, at the same time. This is a pattern that can be learned by the system. The system can gather and record details including the time of day that this cooking occurs, the length of time and temperature used, even the weight of the pot on the stovetop, in order to determine whether there is a pattern. The system may then use the pattern to assist the user with the use of the system. For example, once the system has learned the pattern over the course of at least three (3) or more detections of the pattern, the next time the user attempts to cook something at the same day/time, the system may ask the user if the user is cooking the learned food. The system may pre-set the temperature and/or timer required for that food. The system may then have the capability to automatically shut off the temperature or the burner once the cooking is completed based on the patterns it has previously detected.

In a particular example, if a user boils eggs every week on Tuesday night at the same time, the system would learn this pattern after at least three occasions of this occurring. When the system then detects a pot on the stove with a similar weight on a Tuesday evening at the same time as previously detected, it will ask the user if the user would like to start boiling eggs. Upon input from the user confirming the same, the system will automatically detect the heat and length of time required to boil the eggs. The system can be set to automatically shut off upon completion of the boiling time.

In some non-limiting embodiments, the system may communicate data to the remote device, wherein the remote device may include a software application on a cellular device. In this instance, the software application may, for example, include a fitness or health tracker application. In some embodiments, the health or fitness tracker application may require logging of calories to track daily consumption, for example. The system described herein may communicate data to the health or fitness tracker application to automatically input nutritional information related to the food being cooked (i.e., hardboiled eggs) into the software application avoiding the need for the user to manually input such information.

In another non-limiting embodiment, the system may communicate data to the remote device relating to the product being cooked to suggest to the user to add that product to a grocery list. For example, if the system detects you have made two (2) hardboiled eggs each day for five (5) days, the system may detect you are low on eggs and may suggest via the signal output component that you may consider restocking eggs or ask whether to add eggs to your grocery list. The system may then be associated with a smart device and may add, upon optional approval by the user, eggs to the grocery list on the smart device, for example. Another example could include when the user is cooking pasta (which may be a favorite item recognized by the system), that part or all of the box of pasta was used, and may suggest to the user that the user may want to add a box of pasta to the grocery list.

Other types of sensors that may be used in the system include Lidar, thermal, ultraviolet sensors, infrared sensors, and smoke sensors. Fluid detection sensors like a fluid flow sensor may also be used, in some embodiments, to determine whether, for example, a fluid within a container on the stovetop is flowing over the container. In some examples, when a pot is used to boil eggs, a fluid flow sensor may detect overflow of water from the pot and the system may send an alert through the output device that the pot has reached temperature and that the fluid is overflowing, and/or that the temperature should be lowered. In some non-limiting embodiments, once the pot overflows and fluid flow sensor detects fluid has overflowed, the system can automatically decrease the temperature of the burner, or may automatically shut off.

In another example, certain foods must be cooked at a first temperature for a first predetermined amount of time and then at a second temperature for a second predetermined amount of time. The system may be programmed such that the food being cooked would be cooked at the first temperature for the first pre-determined amount of time, and then the system would automatically adjust to the second temperature for the second predetermined amount of time.

Other types of notifications possible with the system embodiments described herein is a notification based on the type of cooking hardware being used. For example, certain types of pots or pans must be used within an ideal temperature range. The type of pot or pan being used may be entered into the system by the user, and the system may alert the user when the temperature is outside the ideal cooking range for that type of cooking hardware. In another embodiment, based on the type of cooking hardware, the food may need to be cooked at an ideal temperature (for example, Green Pan vs. cast-iron skillet cooks food at different temperatures). Once the system detects that a temperature has been reached within the ideal temperature range, the system provides an output to indicate that the cooking hardware is ready to receive the food to be cooked therewithin.

In a non-limiting embodiment, the system may operate without a cooking time or non-cooking time threshold. In one example, a user can control the cooking device from a phone application to turn off or adjust the cooking device temperature. Consequently, when no cooking time/non-cooking time threshold is used, the cooking device may be left on for an extended period of time. Should a user leave the location of the system and cooking device, the user can operate and shut down the cooking device remotely by way of a software application, for example, on the users' phone. By way of the application a user may be able to view, for example, on a stovetop which burners are activated and/or whether the oven was left on, and may also be able to control the temperature and/or turn on/shut off each burner independently of one another or shut off the cooking device entirely.

The system may be built into a cooking device or may be adapted to the cooking device. In at least one embodiment, the system may be a stand-alone system, which may be configured to work with a cooking device, wherein the system described herein may be obtained separate and apart from the cooking device and adapted to work with the cooking device, i.e., applied aftermarket to the stove or oven system to work therewith.

The system may further include, in another embodiment, facial recognition software, such that a user's face may be programmed with the system so that upon identification by the system camera, the system may be controlled by that user, or the system may populate saved, pre-set, learned, or favorite cooking patterns of that user. In some embodiments, the system may be configured such that the device may be inoperable unless the user's face is recognized by the system camera, or by a camera associated with the system (i.e., a smartphone camera with facial recognition software, wherein said smartphone is associated with the device). If the device is attempted to be operated by a user that is not recognized by the facial recognition software (i.e., a child in the home that is not approved to use the system or an animal in the home who could access the system), the system and stovetop device would remain inoperable, and an output may be sent by the signal output component of the system to a user, a remote device, or other.

In another embodiment, a locking device could prevent use of the system or the stovetop device. The locking device may include a software or hardware lock, or a mechanical lock. The locking device may be set by a user of the system, and could prevent a child or animal or other individual not approved to use the system or stovetop device from using the device. The locking device could maintain the system in an inoperable condition, preventing the stovetop from being turned on, for example, until unlocked by the user. Unlocking of the locking device could include entering a passcode, using a key, or biometrics such as fingerprinting or other methods known in the art to recognize the approved user.

The system embodiments described herein may allow a user to operate the system hands-free. This may be by voice commands (via Amazon Alexa®, or Google®, for example), or by facial recognition in non-limiting examples. These features may be particularly useful in a commercial kitchen or restaurant to avoid or reduce the spread of germs, etc.

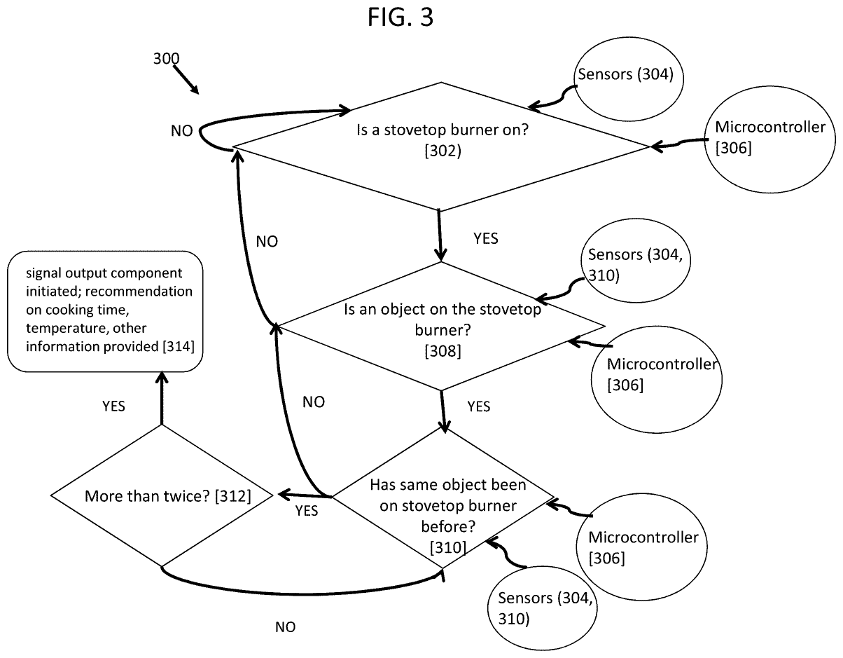

In the embodiment shown in FIG. 3 a method 300 of using a cooking device safety system is provided. The method includes determining whether a stovetop burner is on 302, in one embodiment, which takes into account input from sensors 304, and microcontroller 306, for example, which includes a timer in one embodiment. If it is determined that the stovetop burner is not on, it reverts back to the question whether the stovetop burner is on in step 302 until it determines that the stovetop burner is on. When it is determined that the stovetop burner is on, the method continues to step 308, wherein it determines whether or not an object is on the burner. Sensor input 304, 310 and microcontroller input 306 may be used at this step 308 to determine, for example, the weight of an object on the burner, or the presence of an object on the burner. The microcontroller 306 may be used to determine the date/time of the object of the weight determined on the burner to record data related to patterns in use of the device. If it is determined by the system that an object of the same weight and/or size as detected by the sensors 304, 310 has bene on the stovetop burner before in step 310, and at step 312, it is detected that the object has been on the stovetop burner more than twice, the system moves to step 314 wherein the signal output component may be initiated, it may provide a recommendation on cooking time, temperature, or other details related to that object. If it is determined at step 310 that the answer in no, then the method continues back to step 308. If it is determined that the object has been on the burner less than two previous times in step 312, then the method reverts back to step 310.

The method 300 provides one example of a series of steps for learning patterns of a user during use of the system, wherein the patterns can be used to make the process more efficient, and provide more automation during cooking by the user with the system.

As discussed throughout herein, the system pertains to detecting and controlling a cooking device, wherein the cooking device may include a stove, a stovetop, an oven, a microwave, or a barbeque grill, in non-limiting examples. In all embodiments herein, the system may include, instead, or in addition, control and detection of an oven (or other cooking device) including sensor(s) placed in the oven (or other cooking device) and communication and control via a software application. In every instance where the stovetop burner temperature is mentioned, the oven temperature or microwave control or barbeque grill can be monitored and controlled in a similar manner. Users can also access, control and modify the operation of the cooking device as discussed with respect to the stove or other cooking device herein.

A light or proximity sensor may be used in one or more embodiments to detect whether an object has been placed on or adjacent to a burner or stovetop. The light may project from the surface or from beneath the surface of the stovetop or stovetop burner until the object obstructs the light, consequently indicating that an object has been placed on the stovetop.

Additional sensors of the medicament delivery training device include perpendicularity sensors, orientation sensors, resistive sensors, and tactile sensors, alignment sensors, accelerometers, gyroscopes, and perpendicularity light sensors or any other sensor suitable for detecting one or more of the conditions associated with the system, including but not limited to contact or proximity between a stovetop burner and an object and/or activation or inactivation of the stovetop burner.

In some embodiments, the system includes a microprocessor. The system may also include circuitry, which may include in part, the microprocessor and the signal output component for initiating audio, and visual, outputs, among other electronic components. These components may be operatively coupled by electrical conductors, however, in other embodiments the components may be operatively coupled without being physically connected. For example, in some embodiments, at least a portion of the components included in an electronic circuit system can be inductively coupled. In other embodiments, at least a portion of the components included in an electronic circuit system can be evanescently coupled.

The circuitry of the system may include a flexible printed circuit board to electronically couple with the components contained therein. The circuitry may be disposed in any suitable manner relative to the housing of the stovetop device, or a separate housing including only the system described herein in one non-limiting embodiment. In some embodiments, for example, the circuitry can be integrated with the stove. The circuitry can be contained within a housing separate from the stovetop, configured to be associated with the stovetop for operation, for example, and/or it may be partially or fully assembled concurrently with and/or with the same processes of the stove device. The circuitry may alternatively or in addition be provided on the outer portion of the housing of the stovetop device.

In yet another embodiment, a non-transitory computer-readable medium embedded in a system as described herein is disclosed. The non-transitory computer readable medium stores instructions executable by the microprocessor or another processing device to cause the processing device to output an alert or information by visual or audio means, for example, via the signal output device in response to sensor input.

Some embodiments of the invention relate to a computer storage product with a computer-readable medium having instructions or computer code thereon for performing various computer-implemented operations. The media and computer code may be those specially designed and constructed for the purposes of the invention, or they may be of the kind well known and available to those having skill in the computer software arts. Examples of computer-readable media include, but are not limited to: magnetic storage media such as hard disks, floppy disks, and magnetic tape; optical storage media such as Compact Disc/Digital Video Discs (“CD/DVDs”), Compact Disc-Read Only Memories (“CD-ROMs”), and holographic devices; magneto-optical storage media such as floptical disks; carrier wave signals; and hardware devices that are specially configured to store and execute program code, such as Application-Specific Integrated Circuits (“ASICs”), Programmable Logic Devices (“PLDs”), and ROM and RAM devices. Examples of computer code include, but are not limited to, micro-code or micro-instructions, machine instructions, such as produced by a compiler, and files containing higher-level instructions that are executed by a computer using an interpreter. For example, an embodiment of the invention may be implemented using Java, C++, or other object-oriented programming language and development tools. Additional examples of computer code include, but are not limited to, control signals, encrypted code, and compressed code or code located remotely on the neural network.

Powering on the system, in some embodiments, initiates the system functions; however, the system functions may be automatically initiated during use of the stove device.

A control interface may be associated with the system, either by wired connection or wirelessly connected thereto. The control interface may be provided on the remote device described in embodiments herein.

In some embodiments, the device is associated with a memory storage module which may be either a removable or a non-removable memory storage module. Memory contained in this module may include various languages of audio, updating information for the system, information about data, usage and history of usage of the device, as well as trending results, for example.

The remote device described herein may include, for example, a remote communications network, a computer, a cell phone, a personal digital assistant (PDA) or the like. Such an arrangement can be used, for example, to download replacement processor-readable code from a central network to the memory module or other memory of the system or to provide updates to the system. In some embodiments, the circuitry of the remote device can download or obtain information associated with the system embodiments described herein.

A network interface can be associated with the system embodiments described herein and can be configured to transmit information to and/or receive information from the circuitry of the system to and/or from a central network, such as, for example, an emergency response network. In some embodiments, for example, the system can notify an emergency responder regarding information that has been collected, for example, pertaining to time stamps indicating when the burner was initiated, how long the burner was left activated, how often the system alerts a user, among other information. In other embodiments, as described herein, the system can transmit information to and/or from a third party, such as a physician, an emergency contact and/or the manufacturer of a stovetop device, including information related to malfunctions of the device and/or the system as needed. Such information can include, for example, the dates and times of the alerts delivered, length of time of an activated burner prior to alert or shut off of the burner, or the like. This information may be helpful in securing the safety of the user of the system and stovetop device, as well as reporting error conditions in device or system operation.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. As a non-limiting example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 7.

What is claimed is:

1. A cooking device safety system, comprising a cooking device, comprising:
at least one first sensor to detect the presence of an object on or adjacent to a stovetop burner;
at least one second sensor to detect a condition of the stovetop burner;
at least one third sensor to detect a weight of the object on the burner and/or a temperature of the burner;
wherein the first, second and/or third sensors send inputs to the system;
a microcontroller to detect a date and time of use of the cooking device;
wherein the system collects and stores data related to the inputs from the first sensor, second sensor and/or third sensor by the microcontroller, to determine a cooking pattern of a user;
wherein based on the cooking pattern of the user, the system provides an output to the user via a signal output device; and, optionally,
at least one transceiver to send a signal from the first, second and/or third sensor to a remote device.

2. The stovetop safety system of claim 1, wherein the system is communicatively connected to the remote device via wired or wireless communication.

3. The cooking device safety system of claim 2, wherein the remote device comprises a cellular device.

4. The cooking device safety system of claim 1, wherein the transceiver receives a signal from the at least one first, second and/or third sensor.

5. The cooking device safety system of claim 1, wherein the microcontroller comprises a timer.

6. The cooking device safety system of claim 5, wherein the timer comprises a cooking time and a non-cooking time threshold for a stovetop burner.

7. The cooking device safety system of claim 1, wherein based on the cooking pattern detected during use of the device, the system provides an output regarding use of the device.

8. The cooking device safety system of claim 7, wherein a cooking pattern is detected when the system detects a) an input from the third sensor and the date and time of that input occurs on at least three (3) times, and optionally, b) an input from the microcontroller.

9. The cooking device safety system of claim 1 wherein the cooking time threshold and non-cooking time threshold may be set in the system based on information from the cooking pattern detected.

10. The cooking device safety system of claim 1, wherein the system comprises facial recognition software.

11. The cooking device safety system of claim 10, wherein the system comprises a camera, said camera for receiving an image of a face of a user and via facial recognition software, detecting whether an input may be received from the user.

12. The cooking device safety system of claim 12, wherein the input from the user comprises voice commands and/or haptic input.

13. The cooking device safety system of claim 1, wherein the remote device is communicatively connected to the system to monitor and receive input from the system, and to provide input to the system, comprising activating or inactivating the burner(s), adjusting the temperature of the burner(s), activating the signal output device and/or sending a signal to a third party.

14. The cooking device safety system of claim 1, wherein the signal output device comprises a speaker, a light, a display, a scent-emitting component, and/or a vibratory component, said signal output device to provide an alert to a user.

15. A method for providing a smart stovetop system environment, comprising:
detecting a cooking pattern based on input from a stovetop burner including time and date of use of burner, length of time of user of burner, temperature range of burner during length of time of use of the burner detected;
recording the cooking pattern, and
providing output to a user of the system based on the cooking pattern detected;
logging each cooking pattern;
wherein after three (3) of the same cooking patterns are detected, the system can provide suggestions to a user based on the cooking pattern for future use of the system.
